(19) United States
(12) Patent Application Publication
(10) Pub. No.: US 2018/0066344 A1
(43) Pub. Date: Mar. 8, 2018

(54) WIRE ROD FOR USE IN BOLTS THAT HAS EXCELLENT ACID PICKLING PROPERTIES AND RESISTANCE TO DELAYED FRACTURE AFTER QUENCHING AND TEMPERING, AND BOLT

(71) Applicant: KABUSHIKI KAISHA KOBE SEIKO SHO(KOBE STEEL, LTD.), Kobe-shi (JP)

(72) Inventors: Yosuke MATSUMOTO, Kobe-shi (JP); Masamichi CHIBA, Kobe-shi (JP)

(73) Assignee: KABUSHIKI KAISHA KOBE SEIKO SHO(KOBE STEEL, LTD.), Kobe-shi (JP)

(21) Appl. No.: 15/561,530

(22) PCT Filed: Mar. 14, 2016
(86) PCT No.: PCT/JP2016/058034

§ 371 Date: Sep. 26, 2017

(30) Foreign Application Priority Data
Mar. 27, 2015 (JP) 2015-066205

(51) Int. Cl. C22C 38/50; C21D 9/00; F16B 33/00; F16B 33/06

(52) U.S. Cl. CPC C22C 38/50; C21D 9/0093; F16B 35/00; F16B 33/06; F16B 33/008

(57) ABSTRACT

To provide a wire rod for bolts that has excellent acid pickling properties and the resistance to delayed fracture after quenching and tempering, and a bolt using the same. Disclosed is a wire rod for bolts that has excellent acid pickling properties and resistance to delayed fracture, including, in percent by mass: C: 0.3 to 0.6%; Si: 1.0 to 3.0%; Mn: 0.1 to 1.5%; P: more than 0% and 0.020% or less; S: more than 0% and 0.020% or less; Cr: 0.3 to 1.5%; Al: 0.02 to 0.10%; and N: 0.001 to 0.020%, with the balance being iron and inevitable impurities, wherein in a d× 1/4 position of the wire rod, where d is a diameter of the wire rod, a ferrite area ratio is in a range of 10 to 40%, with the remaining microstructure being bainite, pearlite and an inevitably formed microstructure, and a C content in a position at a depth of 0.1 mm from a surface layer of the wire rod is in a range of 50 to 100% of a C content in a base material.

### TECHNICAL FIELD

The present invention relates to a wire rod for use in bolts and a bolt obtained by using the wire rod. More specifically, the present invention relates to a wire rod for bolts that has excellent acid pickling properties and resistance to delayed fracture after quenching and tempering, and to bolts obtained by using the same.

### BACKGROUND ART

Bolts for use in automobiles, various industrial machines, etc., are desired to have high strength and to improve the resistance to delayed fracture. Although a variety of causes for the delayed fracture has been pointed out, a hydrogen embrittlement phenomenon is generally considered to affect the delayed fracture.

The hydrogen embrittlement phenomenon is caused by introduction and diffusion of hydrogen into the steel, generated by a corrosion reaction onto the surface of the steel (hereinafter sometimes referred to as a “diffusible hydrogen”). For this reason, the improvement in corrosion resistance of steel has been conventionally regarded as an effective means for preventing delayed fracture. However, once the corrosion resistance is improved, even after pickling is applied to the steel to remove scales, some of them still remain. It is pointed out that the remaining scales could cause flaws in wire-drawing and/or cracking in forging. Because of this, the improvement in the acid pickling properties of a wire rod becomes a new issue, but does not necessarily serve as an effective means for suppressing hydrogen embrittlement.

A technique has been proposed that stabilizes transition carbides, such as ε-carbides, by increasing an amount of added Si, thereby detoxifying the diffusible hydrogen. For example, Patent Document 1 discloses a bolt that has a predetermined component composition and an austenite grain size number of a bolt shaft part of 9.0 or more. Further, a G value (%) of the bolt satisfies a formula below: (L/LO)×100≦60 where the G value (%) indicates a rate of carbides precipitated at the austenite grain boundaries in the bolt shaft part. This technique enhances the strength of the austenite grain boundaries acting as a starting point of the delayed fracture and reduces the amount of hydrogen trapping sites, such as carbides. Thus, the high-strength bolt exhibiting excellent resistance to hydrogen embrittlement can be obtained not only in an environment with a small content of hydrogen comparatively, but also in an environment with a large content of hydrogen that can be consumed by all hydrogen trapping sites.

Patent Document 2 discloses a steel wire rod for springs that has excellent decarburization resistance and wire-drawability. The steel wire rod has a predetermined component composition. An average grain size Dc of a central part of the steel wire rod is 80 μm or less, while an average grain size Ds of a surface layer part of the steel wire rod is 3.0 μm or more. This technique can produce the steel wire rod for springs that exhibits excellent wire-drawability without experiencing decarburization after hot-rolling.

Patent Document 3 discloses a steel wire rod for a high-strength spring that has excellent shaving processability. The steel wire rod has a predetermined component composition and exhibits a microstructure mainly formed of pearlite. Further, an average value Pave of grain size numbers of pearlite nodules in the steel wire satisfies 6.0≦Pave≦12.0. Moreover, a total decarburization depth of a surface layer in the steel wire is 0.20 mm or less. Furthermore, the amount of Cr-based alloy carbides is 7.5% or less. This technique can produce the steel wire rod for a high-strength spring that has good shaving processability and scrap dischargeability, and additionally can exhibit satisfactory SV processability that does not cause a break in the wire rod during the SV process.

Patent Document 4 discloses a manufacturing method for a cold-forging steel in which a steel material with a predetermined component composition is subjected to a first heating hold process, a second heating hold process, a first cooling process, and a second cooling process in this order under predetermined conditions, thereby spheroidizing carbides in the steel material. This technique can surely perform spheroidize annealing, even on a steel material having a Cr content of 0.4% or less, and can produce the steel material with excellent cold forgeability.

### PRIOR ART DOCUMENT

### Patent Document

Patent Document 1: JP 2013-163865 A

Patent Document 2: JP 2009-068030 A

Patent Document 3: JP 2013-213238 A

Patent Document 4: JP 2014-201812 A

### DISCLOSURE OF THE INVENTION

### Problems to be Solved by the Invention

For example, in the technique mentioned in Patent Document 1, cooling after finish rolling is performed at normal cooling rate, resulting in a high decarburization rate. Because of this, abnormal grain growth occurs when heating for quenching after forming a bolt, which degrades the resistance to delayed fracture. In the technique mentioned in Patent Document 2, the cooling rate after rolling is so slow that an area ratio of ferrite-pearlite is increased, deteriorating the dispersibility of carbides in the spheroidize annealing, and thereby occasionally causing cracks when producing a bolt by cold forging.

In the technique mentioned in Patent Document 3, the wire rod has a metallic microstructure that mainly contains pearlite, thus deteriorating the dispersibility of carbides in the annealing, and thereby occasionally causing cracks during cold forging. In the technique mentioned in Patent Document 4, the amount of added Si is low, whereby the transition carbides cannot be stabilized, thus making it difficult to ensure the resistance to delayed fracture.

The present invention has been made in view of the foregoing circumstances. It is an object of the present invention to provide a wire rod for bolts that has excellent acid pickling properties and the resistance to delayed fracture after quenching and tempering (hereinafter simply referred to as the “resistance to delayed fracture”), and a bolt.

### Means for Solving the Problems

A wire rod for bolts according to the present invention that has excellent acid pickling properties and resistance to delayed fracture, which can solve the above-mentioned problem, includes, in percent by mass: C: 0.3 to 0.6%; Si: 1.0 to 3.0%; Mn: 0.1 to 1.5%; P: more than 0% and 0.020% or less; S: more than 0% and 0.020% or less; Cr: 0.3 to 1.5%; Al: 0.02 to 0.10%; and N: 0.001 to 0.020%, with the balance being iron and inevitable impurities, wherein in a d×¼ position of the wire rod, where d is a diameter of the wire rod, a ferrite area ratio is in a range of 10 to 40%, with the remaining microstructure being bainite, pearlite and an inevitably formed microstructure, and a C content in a position at a depth of 0.1 mm from a surface layer of the wire rod is in a range of 50 to 100% of a C content in a base material.

In a preferred embodiment, the wire rod for bolts further includes, in percent by mass, at least one of elements (a) to (e) below:

(a) at least one element selected from the group consisting of Cu: more than 0% and 0.5% or less, Ni: more than 0% and 1.0% or less, and Sn: more than 0% and 0.5% or less,

(b) at least one element selected from the group consisting of Ti: more than 0% and 0.1% or less, Nb: more than 0% and 0.1% or less, and Zr: more than 0% and 0.3% or less.

(c) at least one element selected from the group consisting of Mo: more than 0% and 3% or less and W: more than 0% and 0.5% or less.

(d) V: more than 0% and 0.5% or less, and

(e) at least one element selected from the group consisting of Mg: more than 0% and 0.01% or less and Ca: more than 0% and 0.01% or less.

The present invention also includes a bolt that has excellent resistance to delayed fracture obtained by using the above-mentioned wire rod for bolts, wherein a tensile strength of the bolt is 1,400 MPa or more, and each of austenite grain size numbers both at a surface layer of the bolt and in the d×¼ position of the bolt, where d is a diameter of a bolt shaft part, is No. 7.0 or more.

### Effects of the Invention

In the wire rod according to the present invention, the chemical component composition, the metallic microstructure, and the decarburization rate are appropriately controlled, thereby making it possible to achieve both high levels of acid pickling properties and resistance to delayed fracture. Further, the bolt obtained by using the wire rod for bolts according to the present invention has high strength and excellent resistance to delayed fracture.

### MODE FOR CARRYING OUT THE INVENTION

The inventors have diligently studied to ensure the acid pickling properties and the resistance to delayed fracture. Consequently, it is found that the above-mentioned problems can be achieved by appropriately controlling the chemical component composition, the metallic microstructure, and the decarburization rate. Based on these findings, the present invention has been completed.

In particular, in the present invention, the Si content is increased and the decarburization rate is reduced, thereby making it possible to improve the resistance to delayed fracture. Further, a ferrite area ratio is decreased, thereby making it possible to improve the acid pickling properties. The wire rod for bolts according to the present invention will be described below.

[C content in the position at a depth of 0.1 mm from its surface layer is in a range of 50 to 100% of a C content of a base material]

When a quenching and tempering process is performed in a state where a C-deficient layer is formed on the surface layer of a wire rod, i.e., in a state where a decarburization rate is high, austenite crystal grains are coarsened, thus deteriorating the resistance to delayed fracture. Therefore, to improve the resistance to delayed fracture, the decarburization rate should be as low as possible. The C content in the position at a depth of 0.1 mm from the surface layer is 50% or more of the C content in the base material, preferably 60% or more, and more preferably 65% or more, and is also 100% or less. Note that the C content in the base material is a value obtained by measuring the wire rod in accordance with a combustion-infrared absorption method (JIS G 1211 (2011)).

### [Ferrite Area Ratio: 10 to 40%]

When the content of a hard microstructure, such as martensite, increases, the strength of the wire rod is improved. However, the wire rod absorbs hydrogen during pickling, which might cause embrittlement or breakage of the wire rod. Further, the wire rod tends to cause corrosion and the like. Thus, such a wire rod has deteriorated acid pickling properties. To improve the acid pickling properties, it is necessary to suppress the formation of martensite or the like. In contrast, ferrite does not cause any problems during pickling, such as those mentioned above. Thus, ferrite is a microstructure that is effective in improving the acid pickling properties. Therefore, a ferrite area ratio in the d×¼ position, where d is a diameter of the wire rod (hereinafter sometimes referred to as a “D/4 position”), is 10% or more, preferably 13% or more, and more preferably 15% or more. Meanwhile, if the ferrite area ratio becomes extremely high, the dispersibility of carbides during annealing is reduced, deteriorating the cold forgeability. Further, scales remain even after pickling, which might cause flaws in wire-drawing or cracks in forging. Therefore, the ferrite area ratio is set at 40% or less, preferably 35% or less, and more preferably 30% or less. Note that the microstructure of the wire rod, other than ferrite, is mainly made up of pearlite and bainite, but sometimes contains inevitably formed microstructures, such as martensite and/or residual austenite.

The reasons why the present invention specifies the content ranges of the chemical components in the wire rod for bolts are as follows.

### [C: 0.3 to 0.6%]

C (carbon) is an element effective in ensuring the strength of steel. To ensure a target bolt tensile strength of 1,400 MPa or more, the C content is 0.3% or more, preferably 0.35% or more, and more preferably 0.38% or more. However, any excessive C content degrades the resistance to delayed fracture. Thus, the C content is 0.6% or less, preferably 0.55% or less, and more preferably 0.52% or less.

### [Si: 1.0 to 3.0%]

Silicon (Si) is an element effective in serving as a deoxidizing agent and ensuring the strength of steel. Si suppresses the precipitation of coarse grains of cementite during tempering and also exhibits the effect of improving the resistance to delayed fracture. To efficiently exhibit these effects, the Si content needs to be 1.0% or more, preferably 1.3% or more, and more preferably 1.5% or more. Any excessive Si content widens a ferrite-austenite two-phase region, making it more likely to cause decarburization. Further, an amorphous layer is formed on the surface of the steel, which deteriorates the acid pickling properties. Thus, the Si content needs to be 3.0% or less, preferably 2.7% or less, and more preferably 2.5% or less.

### [Mn: 0.1 to 1.5%]

Manganese (Mn) is an element that is effective in ensuring the strength of steel while exhibiting the function of suppressing the formation of FeS, which would degrade the resistance to delayed fracture, by forming a compound with S. To exhibit these effects, the Mn content is 0.1% or more, preferably 0.15% or more, and more preferably 0.2% or more. Any excessive Mn content coarsens grains of MnS, which serve as a stress concentrating source, thereby deteriorating the cold forgeability and the resistance to delayed fracture. Thus, the Mn content is 1.5% or less, preferably 1.3% or less, and more preferably 1.1% or less.

[P: more than 0% and 0.020% or less]

Phosphor (P) is an impurity element that reduces the toughness and ductility of steel and degrades the resistance to delayed fracture due to enrichment of P at crystal grain boundaries. By decreasing the P content, the resistance to delayed fracture can be improved. The P content is 0.020% or less, preferably 0.015% or less, and more preferably 0.010% or less. The P content is preferably decreased as much as possible. However, it is difficult to set the P content at zero in terms of manufacturing. Consequently, P is occasionally contained in an amount of approximately 0.003% as an inevitable impurity.

[S: more than 0% and 0.020% or less]

Like P, sulfur (S) is an impurity element that reduces the toughness and ductility of steel and degrades the resistance to delayed fracture thereof due to enrichment of S at crystal grain boundaries. By decreasing the S content, the resistance to delayed fracture can be improved. Thus, the S content is 0.020% or less, preferably 0.015% or less, and more preferably 0.010% or less. The S content is preferably decreased as much as possible. However, it is difficult to set the S content at zero in terms of manufacturing. Consequently, S is occasionally contained in an amount of approximately 0.003% as an inevitable impurity.

### [Cr: 0.3 to 1.5%]

Chromium (Cr) is an element effective in ensuring the resistance to delayed fracture while improving the corrosion resistance of steel. To exhibit these effects, the Cr content is 0.3% or more, preferably 0.4% or more, and more preferably 0.5% or more. Meanwhile, any excessive Cr content forms a Cr enrichment layer on the surface layer of the steel, deteriorating the acid pickling properties. Therefore, the Cr content is 1.5% or less, preferably 1.4% or less, and more preferably 1.3% or less.

### [Al: 0.02 to 0.10%]

Aluminum (Al) is an element effective in serving as a deoxidizing agent and in refining crystal grains by forming a nitride. To exhibit these effects, the Al content is 0.02% or more, preferably 0.03% or more, and more preferably 0.035% or more. Meanwhile, any excessive Al content form coarse nitrides, leading to degradation in the cold forgeability and resistance to delayed fracture. Therefore, the Al content is set at 0.10% or less, preferably 0.08% or less, and more preferably 0.06% or less.

### [N: 0.001 to 0.020%]

Nitrogen (N) is an element that forms a nitride with Al, and thereby is effective in refining crystal grains. To exhibit these effects, the N content is 0.001% or more, preferably 0.003% or more, and more preferably 0.004% or more. Meanwhile, any excessive N content leads to an increase in the amount of N in a solid-solution state without forming any compounds, thereby degrading the cold forgeability. Therefore, the N content is set at 0.020% or less, preferably 0.01% or less, and more preferably 0.008% or less.

The basic chemical component composition of the wire rod for bolts according to the invention has been mentioned above, with the balance being substantially iron. Note that inevitable impurities are obviously allowed to be brought and contained in the steel, depending on the situations, including raw materials, construction materials, manufacturing facilities, and the like. It is also effective that the wire rod for bolts in the invention further contains the following elements as appropriate.

[At least one element selected from the group consisting of: Cu: more than 0% and 0.5% or less, Ni: more than 0% and 1.0% or less; and Sn: more than 0% and 0.5% or less]

Copper (Cu), nickel (Ni), and tin (Sn) are elements effective in improving the resistance to delayed fracture of steel, while improving corrosion resistance thereof. To exhibit these effects, the Cu content is preferably 0.03% or more, more preferably 0.1% or more, and still more preferably 0.15% or more. The Ni content is preferably 0.1% or more, more preferably 0.2% or more, and still more preferably 0.3% or more. The Sn content is preferably 0.03% or more, more preferably 0.1% or more, and still more preferably 0.15% or more.

Meanwhile, any excessive Cu content deteriorates the acid pickling properties, and reduces the hot ductility, thereby degrading the productivity of the steel. Therefore, the C content is preferably 0.5% or less, more preferably 0.4% or less, and still more preferably 0.35% or less. Further, when the content of Ni and Sn is excessive, the acid pickling properties also become deteriorated. Thus, the Ni content is preferably 1.0% or less, more preferably 0.8% or less, and still more preferably 0.7% or less. The Sn content is preferably 0.5% or less, more preferably 0.4% or less, and still more preferably 0.3% or less.

[At least one element selected from the group consisting of Ti: more than 0% and 0.1% or less, Nb: more than 0% and 0.1% or less, and Zr: more than 0% and 0.3% or less]

Titanium (Ti), niobium (Nb), and zirconium (Zr) are elements that form a carbonitride with C and N, and thereby are effective in refining crystal grains. Since the formation of a nitride decreases the content of solid-solution N, these elements are effective in improving the cold forgeability. To exhibit these effects, the Ti content is preferably 0.02% or more, more preferably 0.03% or more, and still more preferably 0.04% or more. The Nb content is preferably 0.02% or more, more preferably 0.03% or more, and still more preferably 0.04% or more. The Zr content is 0.03% or more, more preferably 0.08% or more, and still more preferably 0.10% or more.

Meanwhile, any excessive contents of Ti, Nb, and Zr form coarse carbonitrides, thereby degrading the cold forgeability and the resistance to delayed fracture. Thus, the Ti content is preferably 0.1% or less, more preferably 0.08% or less, and still more preferably 0.06% or less. The Nb content is preferably 0.1% or less, more preferably 0.08% or less, and still more preferably 0.06% or less. The Zr content is preferably 0.3% or less, more preferably 0.25% or less, and still more preferably 0.2% or less.

[At least one element selected from the group consisting of Mo: more than 0% and 3% or less and W: more than 0% and 0.5% or less]

Molybdenum (Mo) and tungsten (W) are elements effective in enhancing the strength of steel and in improving the resistance to delayed fracture by forming fine precipitates in the steel. To obtain such effects, at least one of Mo and W is preferably contained. The Mo content is preferably 0.05% or more, more preferably 0.15% or more, and still more preferably 0.20% or more. The W content is preferably 0.03% or more, more preferably 0.08%, and still more preferably 0.10%. Meanwhile, if the contents of Mo and W are excessive, the manufacturing cost will increase. The Mo content is preferably 3% or less, more preferably 2% or less, and still more preferably 1.5% or less. The W content is preferably 0.5% or less, more preferably 0.4% or less, and still more preferably 0.35% or less.

[V: more than 0% and 0.5% or less]

Vanadium (V) is solid-soluted during heating for quenching and then precipitated as a carbide during tempering, thereby forming a hydrogen trapping site. In this way, V becomes effective in improving the resistance to delayed fracture. To exhibit these effects, the V content is preferably 0.01% or more, more preferably 0.05% or more, and still more preferably 0.08% or more. In contrast, any excessive V content forms coarse carbonitrides, thereby deteriorating the cold forgeability. Thus, the V content is preferably 0.5% or less, more preferably 0.4% or less, and still more preferably 0.3% or less.

[At least one element selected from the group consisting of Mg: more than 0% and 0.01% or less and Ca: more than 0% and 0.01% or less]

Magnesium (Mg) and calcium (Ca) form carbonitrides to prevent austenite crystal grains from being coarsened during heating for quenching and are effective in improving the toughness and ductility of steel as well as the resistance to delayed fracture thereof. To exhibit these effects, the Mg content is preferably 0.001% or more, more preferably 0.002% or more, and still more preferably 0.003% or more. The Ca content is preferably 0.001% or more, more preferably 0.002% or more, and still more preferably 0.003% or more. Meanwhile, any excessive contents of Mg and Ca saturate the above-mentioned effects and lead to an increase in the manufacturing cost. Thus, the Mg content is preferably 0.01% or less, more preferably 0.007% or less, and still more preferably 0.005% or less. The Ca content is preferably 0.01% or less, more preferably 0.007% or less, and still more preferably 0.005% or less.

The wire rod for bolts in the present invention is obtained by smelting steel material with the above-mentioned chemical components, followed by casting and hot-rolling. In particular, to improve the acid pickling properties and the resistance to delayed fracture, it is important to perform the following processes. Specifically, a billet is reheated to 950° C. or higher (hereinafter sometimes referred to as a “billet reheating temperature”) before the rolling, and thereafter is subjected to finish rolling in a temperature range of 900 to 1,100° C. to be formed into a wire rod or steel bar shape. Subsequently, the wire rod or steel bar is cooled to 730° C. at an average cooling rate of 3 to 8° C./sec (hereinafter sometimes referred to as a “cooling rate I”), and then cooled to 350° C. at an average cooling rate of 8 to 13° C./sec (hereinafter sometimes referred to as a “cooling rate II”).

### [Billet Reheating Temperature: 950° C. or Higher]

In the billet reheating, to decrease the deformation resistance in the hot-rolling, the billet reheating temperature is preferably 950° C. or higher, and more preferably 1,000° C. or higher. If the billet reheating temperature is lower than 950° C., the deformation resistance in the hot-rolling is increased. Meanwhile, if the billet reheating temperature becomes extremely high, it will approach the melting temperature of steel. Therefore, the billet reheating temperature is preferably 1,400° C. or lower, more preferably 1,300° C. or lower, and still more preferably 1,250° C. or lower.

### [Finish Rolling Temperature: 900 to 1,100° C.]

If the finish rolling temperature is extremely low, grains of AlN are not refined and dispersed, so that the austenite crystal grains after the quenching becomes coarse. Therefore, the finish rolling temperature is preferably 900° C. or higher, and more preferably 950° C. or higher. Meanwhile, if the finish rolling temperature becomes extremely high, ferrite crystal grains are coarsened, thereby degrading the cold forgeability and the resistance to delayed fracture. Therefore, the finish rolling temperature is preferably 1,100° C. or lower and more preferably 1,050° C. or lower.

Note that also when the steel contains an additive element, such as Ti or Nb, a finish rolling temperature may be in the same temperature range as that of the above-mentioned finish rolling temperature. The finish rolling temperature is preferably 900° C. or higher, and more preferably 950° C. or higher. In this case, the additive element can be precipitated in the steel as fine carbonitrides. Meanwhile, the finish rolling temperature is preferably 1,100° C. or lower, and more preferably 1,050° C. or lower. In this case, the carbonitrides can be sufficiently precipitated.

In the invention, the average cooling rate after the hot-rolling is controlled in two stages while being set higher than a conventional one. Consequently, at a cooling rate I, mentioned below, the decarburization rate can be controlled, while at a cooling rate II, mentioned below, the ferrite area ratio can be controlled.

Cooling Rate I [Average cooling rate after the finish rolling to 730° C.: 3 to 8° C./sec]

Normally, the cooling rate after the finish rolling is set lower to promote softening of a wire rod for bolts. However, in a range of the Si content specified by the present invention, the ferrite-austenite two-phase region is wider than that in a normal steel for bolts. Because of this, if the cooling rate is slow, the excessive decarburization will occur. For this reason, to promote the softening of the wire rod for bolts while preventing the excessive decarburization, the cooling after the finish rolling to 730° C. is desirably performed as quickly as possible. Therefore, the average cooling rate is 3° C./sec or higher, preferably 4° C./sec or higher, and more preferably 4.5° C./sec or higher. Meanwhile, if the average cooling rate is extremely high, martensite is created at the surface layer and/or in the D/4 position of the wire rod, leading to degradation in the acid pickling properties. Therefore, the average cooling rate after the finish rolling to 730° C. is 8° C./sec or lower, preferably 7° C./sec or lower, and more preferably 6.5° C./sec or lower.

Cooling Rate II [Average cooling rate from a temperature of lower than 730° C. to 350° C.: 8 to 13° C./sec]

To control the precipitation ratio of ferrite to become lower and thereby to improve the dispersibility of carbides in the steel during annealing, the average cooling rate to 350° C. needs to be high. Therefore, the average cooling rate from a temperature of lower than 730° C. to 350° C. is 8° C./sec or higher, preferably 9° C./sec or higher, and more preferably 9.5° C./sec or higher. Meanwhile, when the average cooling rate becomes extremely high, the precipitation ratio of ferrite significantly decreases, thus degrading the acid pickling properties. Therefore, the average cooling rate in this temperature range is 13° C./sec or lower, preferably 12° C./sec or lower, and more preferably 11.5° C./sec or lower.

In the wire rod obtained on the above-mentioned conditions, its chemical component composition is appropriately controlled, and additionally, the ferrite area ratio is precisely controlled. Thus, the wire rod has good acid pickling properties and excellent dispersibility of carbides in annealing and cold forgeability. Further, the decarburization of the wire rod is also suppressed, and thereby the coarsening of austenite crystal grains can be suppressed during the heating for quenching. Thus, the wire rod also has excellent resistance to delayed fracture.

The bolt according to the present invention can be manufactured by performing a descaling process, a heat treatment, such as spheroidize annealing, a coating process, and a finish wire-drawing process, onto the above-mentioned wire rod as appropriate to produce a steel wire, and then forming a bolt from the steel wire by cold forging or the like, followed by a quenching and tempering process. To control the austenite grain size, it is desired that the heating temperature before the quenching is preferably 930° C. or lower, more preferably 920° C. or lower, and still more preferably 910° C. or lower. Meanwhile, if the heating temperature before the quenching is extremely low, the martensite transformation does not sufficiently occur during the quenching, whereby the bolt cannot achieve the required strength. Therefore, the heating temperature before the quenching is preferably 870° C. or higher, more preferably 880° C. or higher, and still more preferably 890° C. or higher. Other heating conditions taken before the quenching are not limited specifically, but the following conditions are exemplified.

Heating time before quenching: 10 to 45 minutes

Cooling method: oil cooling, Temperature: room temperature to 70° C.

Atmosphere inside a furnace: atmosphere of a mixed gas consisting of carbon monoxide (RX gas) and carbon dioxide, nitrogen atmosphere, atmospheric air, etc.

The tempering conditions, such as the temperature and the time, can be changed as appropriate, depending on the required strength. The use of the wire rod according to the present invention can produce the bolt that exhibits a tensile strength of 1,400 MPa or more and excellent fracture resistance. Note that the upper limit of tensile strength of the bolt is not limited specifically as long as the requirement of the present invention is satisfied, and thus may be, for example, approximately 1900 MPa.

In the bolt according to the present invention, the austenite crystal grains are refined. As the austenite crystal grains become finer, the toughness and ductility thereof are improved, and the resistance to delayed fracture thereof is also improved. In the austenite grain size number of the bolt according to the present invention, each of austenite grain size numbers both at the surface layer and in the D/4 position of the bolt is preferably No. 7.0 or more and more preferably No. 9 or more. The finer the austenite crystal grains, the better their properties become. In the normal heat treatment, the austenite grain size number is approximately No. 14 or less.

This application claims priority based on Japanese Patent Application 2015-066205, field on Mar. 27, 2015, the disclosure of which is incorporated by reference herein.

### EXAMPLES

The present invention will be more specifically described below by way of Examples, but is not limited to the following Examples. Various modifications can be obviously made to these Examples as long as they are adaptable to the above-mentioned and below-mentioned concepts and are included within the technical scope of the present invention.

### Manufacture of Wire Rod

Steel materials (steel types A to M and A1 to M1) with the chemical component compositions shown in Table 1 were smelted, cast, and hot-rolled, thereby manufacturing wire rods, each having a diameter of 12 mm. During these processes, each of these wire rods was subjected to the billet reheating and then the finish rolling, followed by cooling at the average cooling rate I and the average cooling rate II on the conditions shown in Table 2.

The ferrite area ratio and the C content in the position at a depth of 0.1 mm from the surface of the obtained wire rod were measured, thereby evaluating the acid pickling properties.

### (1) Ferrite Area Ratio

Each wire rod was cut at its section perpendicular to its axis (hereinafter referred to as the “cross-section”), and the metallic microstructure of the cross-section was etched in accordance with “Steel-macroscopic examination” defined by JIS G 0553 (2015). Any area with 0.156 mm² in the D/4 position of the wire rod was observed with an optical microscope at a magnification of 200 times, and an obtained image was analyzed, thereby calculating a ferrite area ratio. This observation was performed at four field of views on the wire rod, and the measured values were averaged to determine a ferrite area ratio.

### (2) C Content in the Position at a Depth of 0.1 mm from its Surface Layer

The C content in the position at the depth of 0.1 mm from the surface layer of each wire rod was measured by an electron probe micro analyzer (EPMA) line analysis. By using the measured value, a ratio of the C content in the 0.1 mm position to a C content in a base material was calculated, as shown in Table 2.

### (3) Acid Pickling Properties

The wire rod was subjected to pickling by being immersed in a hydrochloric acid bath, and then the surface of its cross-section was observed to visually check the presence or absence of remaining scales. Pickling conditions were set as follows: hydrochloric acid concentration: 25%; hydrochloric acid temperature: 70° C.; and immersion time: 8 minutes. The samples having no remaining scales around its periphery were rated as Pass “P”, while the samples having any scale remaining on at least a part of the surface were rated as Fail “F”.

### Manufacture of Steel Wire

Each of the above-mentioned wire rods was subjected to pickling on the pickling conditions for evaluation of the acid pickling properties, followed by a descaling process. Then, the wire rod was subjected to the spheroidize annealing, the descaling process, the coating process, and the finish wire-drawing on the following conditions, thereby fabricating a steel wire. Note that the wire rods rated as “F” in the above-mentioned evaluation of the acid pickling properties were excluded from this procedure.
Spheroidize Annealing Conditions:

Soaking Temperature: 760° C.

Soaking Time: 5 hours

Average Cooling Rate: 13° C./hr.

Extraction Temperature: 685° C.
Descaling Conditions:

Hydrochloric Acid Concentration: 25%

Hydrochloric Acid Temperature: 70° C.

Immersion Time: 8 minutes
Coating Process Conditions:

Coating Type: Lime Coating

Immersion Time: 10 minutes
Finish Wire-Drawing Conditions:

Wire-Drawing Speed: 1 m/sec

Area Reduction: 8% (φ9.3 [symbol] φ9.06)

### Manufacture of Bolt

Each of the obtained steel wires was subjected to cold forging using a multistage former, thereby producing a flange bolt with M10 mm×P1.5 mm and Length 80 mm. Here, M means a diameter of the bolt shaft part, and P means a pitch.

### (4) Cold Forgeability

After the above-mentioned cold forging, the cold forgeability of each bolt was evaluated by the presence or absence of flange cracks. With regard to the cold forgeability, the samples having no cracks are rated as Pass “P”, while the samples having any crack are rated as Fail “F”.

The bolts produced in the above-mentioned ways were subjected to a quenching and tempering process on the conditions shown in Table 3. At this time, the heating time for the quenching was set 15 minutes, the atmosphere inside the furnace was atmospheric air, and the quenching was oil-cooling at 25° C. The tempering heating time was 45 minutes. Note that the samples rated as Fail with regard to the cold forgeability were excluded from this procedure.

The austenite grain size, tensile strength, and resistance to delayed fracture of each bolt were evaluated.

### (5) Austenite Grain Size

The bolt shaft part was cut at its section perpendicular to the bolt shaft (hereinafter referred to as a “cross-section”). Any areas with 0.039 mm² located both in the d×¼ position of the bolt, where d is a diameter of the cross-section and at the outermost surface of the bolt were observed with an optical microscope at a magnification of 400 times. Subsequently, a prior austenite grain size number of each area was measured in accordance with “Steels-Micrographic Determination of The Apparent Grain Size” defined by JIS G 0551 (2015). The measurement of the grain size number was performed on four fields of view to determine an average of these grain size numbers, which was defined as the austenite grain size number. The samples having an austenite grain size number of No. 7.0 or more were rated as Pass “P”, while the samples having an austenite grain size number of less than No. 7.0 were rated as Fail “F”.

### (6) Tensile Strength

The tensile strength of the bolt was determined by a tensile test in accordance with JIS B1051 (2014). The samples having a tensile strength of 1,400 MPa or more were rated as Pass, while the samples having a tensile strength of less than 1,400 MPa were rated as Fail.

### (7) Resistance to Delayed Fracture

The resistance to delayed fracture of the bolt was evaluated by fastening the bolt by a jig toward a yield point and then repeating 10 cycles of processes on the bolt. Each cycle involves (a) immersing the bolt together with the jig into 1% HCl for 15 minutes, (b) exposing the bolt to the atmospheric air for 24 hours, and (c) confirming the presence or absence of fracture in the bolt. Regarding each sample, ten bolts were evaluated. The samples having no fracture in their bolts were rated as Pass “P”, while the samples having any fracture even in one of the bolts were rated as Fail “F”.

TABLE 1

| Steel | | | | | | | | | | | | | | | | | | | |
|---|---|---|---|---|---|---|---|---|---|---|---|---|---|---|---|---|---|---|---|
| mate- | | | | | | | | | | | | | | | | | | | |
| rial | Chemical composition [% by mass] | | | | | | | | | | | | | | | | | | |
| No. | C | Si | Mn | P | S | Cr | Al | N | Cu | Ni | Sn | Ti | Nb | Zr | Mo | W | V | Mg | Ca |
| A | 0.41 | 1.75 | 0.18 | 0.013 | 0.012 | 0.83 | 0.025 | 0.0048 | | | | | | | | | | | |
| B | 0.38 | 1.51 | 0.45 | 0.010 | 0.012 | 0.50 | 0.030 | 0.0045 | | | | | | | | | | | |
| C | 0.54 | 1.40 | 0.46 | 0.008 | 0.010 | 0.81 | 0.051 | 0.0081 | | | | | | | | | | | |
| D | 0.33 | 2.34 | 0.80 | 0.017 | 0.018 | 0.49 | 0.053 | 0.0079 | | 0.71 | | | | | | | | | |
| E | 0.50 | 1.30 | 0.83 | 0.007 | 0.005 | 0.75 | 0.079 | 0.0045 | | | | | 0.050 | | | | | | |
| F | 0.40 | 1.75 | 0.15 | 0.008 | 0.010 | 1.05 | 0.030 | 0.0050 | 0.23 | 0.45 | | 0.048 | | | | | 0.153 | | |
| G | 0.33 | 2.49 | 0.13 | 0.010 | 0.008 | 1.33 | 0.071 | 0.0125 | | | | | | 0.113 | | | | | |
| H | 0.35 | 2.21 | 1.20 | 0.018 | 0.016 | 1.35 | 0.025 | 0.0043 | | | 0.25 | | | | | | | | |
| I | 0.38 | 1.75 | 0.75 | 0.015 | 0.013 | 1.20 | 0.030 | 0.0050 | | | | | | | | | 0.220 | | |
| J | 0.31 | 1.15 | 0.28 | 0.013 | 0.012 | 0.79 | 0.025 | 0.0048 | | | | | | | | | | 0.0021 | 0.0025 |
| K | 0.41 | 1.13 | 1.15 | 0.008 | 0.010 | 0.81 | 0.051 | 0.0039 | | | | | | | 1.53 | | | | |
| L | 0.54 | 1.51 | 1.21 | 0.010 | 0.013 | 0.53 | 0.049 | 0.0040 | | | 0.30 | | | 0.175 | | 0.40 | | | |
| M | 0.32 | 2.50 | 0.20 | 0.009 | 0.007 | 0.51 | 0.045 | 0.0045 | | | | 0.075 | | | | | | | |
| A1 | 0.23 | 1.52 | 0.80 | 0.013 | 0.015 | 0.80 | 0.051 | 0.0040 | | | | | | | | | | | |
| B1 | 0.71 | 1.73 | 0.20 | 0.011 | 0.015 | 1.00 | 0.023 | 0.0045 | | | | | | | | | | | |
| C1 | 0.43 | 0.75 | 0.15 | 0.015 | 0.017 | 1.13 | 0.053 | 0.0045 | | | | | | | | | | | |
| D1 | 0.41 | 3.22 | 0.82 | 0.017 | 0.014 | 0.94 | 0.062 | 0.0039 | | | | | | | | | | | |
| E1 | 0.48 | 1.21 | 0.03 | 0.010 | 0.016 | 0.41 | 0.055 | 0.0031 | | | | | | | | | | | |
| F1 | 0.33 | 1.55 | 1.73 | 0.008 | 0.007 | 0.59 | 0.048 | 0.0075 | | | | | | 0.053 | | | | | |
| G1 | 0.38 | 1.76 | 1.10 | 0.025 | 0.017 | 0.78 | 0.049 | 0.0028 | | | | | 0.035 | | | | | | |
| H1 | 0.54 | 1.75 | 0.19 | 0.011 | 0.025 | 1.15 | 0.030 | 0.0103 | | | | 0.051 | | | | | | | |
| I1 | 0.51 | 1.21 | 0.90 | 0.009 | 0.010 | 0.10 | 0.033 | 0.0054 | | | | | | | | | 0.210 | | |
| J1 | 0.44 | 2.17 | 0.86 | 0.013 | 0.015 | 1.83 | 0.030 | 0.0061 | | | | | | | | 0.20 | | | |
| K1 | 0.49 | 2.33 | 0.16 | 0.017 | 0.019 | 1.17 | 0.010 | 0.0135 | | | | | | | 0.22 | | | | |
| L1 | 0.38 | 2.81 | 0.14 | 0.007 | 0.005 | 0.90 | 0.183 | 0.0041 | | | 0.21 | | | | | | | | |
| M1 | 0.40 | 1.68 | 0.57 | 0.004 | 0.006 | 1.21 | 0.035 | 0.0238 | | 0.73 | | | | | | | | | |

TABLE 2

| | | | | | | | (2) C content in a | (2) Ratio with |
|---|---|---|---|---|---|---|---|---|
| | | Billet | | | | | position at a depth | respect to a C |
| | Steel | reheating | Finish rolling | Average | Average | (1) Ferrite | of 0.1 mm from the | content in base |
| Sample | material | temperature | temperature | cooling rate I | cooling rate II | area ratio | surface layer | material |
| No. | No. | [° C.] | ° C. ° C.] | [° C./sec] | [° C./sec] | [%] | [% by mass] | [%] |
| 1 | A | 950 | 950 | 5 | 10 | 35 | 0.27 | 66 |
| 2 | A | 1,000 | 950 | 3 | 10 | 33 | 0.23 | 56 |
| 3 | A | 1,050 | 950 | 8 | 10 | 37 | 0.33 | 80 |
| 4 | B | 1,050 | 950 | 5 | 8 | 39 | 0.27 | 71 |
| 5 | B | 1,000 | 950 | 5 | 13 | 14 | 0.26 | 68 |
| 6 | C | 1,100 | 950 | 5 | 8 | 34 | 0.41 | 76 |
| 7 | C | 1,000 | 950 | 8 | 8 | 33 | 0.49 | 91 |
| 8 | D | 1,100 | 950 | 6 | 13 | 18 | 0.24 | 73 |
| 9 | D | 1,050 | 950 | 8 | 8 | 35 | 0.31 | 94 |
| 10 | E | 1,100 | 1,000 | 5 | 10 | 30 | 0.31 | 62 |
| 11 | F | 1,100 | 1,000 | 5 | 10 | 38 | 0.25 | 63 |
| 12 | G | 1,000 | 950 | 8 | 10 | 31 | 0.33 | 87 |
| 13 | H | 1,000 | 950 | 8 | 10 | 28 | 0.29 | 83 |
| 14 | I | 1,000 | 950 | 5 | 13 | 21 | 0.24 | 63 |
| 15 | J | 1,000 | 950 | 7 | 13 | 28 | 0.36 | 80 |
| 16 | K | 1,000 | 950 | 7 | 13 | 12 | 0.32 | 78 |
| 17 | L | 1,000 | 950 | 5 | 10 | 38 | 0.33 | 61 |
| 18 | M | 1,100 | 1,000 | 4 | 10 | 31 | 0.18 | 56 |
| 19 | A | 1,000 | 950 | 1 | 10 | 34 | 0.08 | 20 |
| 20 | A | 1,000 | 950 | 12 | 10 | 8 | 0.40 | 98 |
| 21 | B | 1,000 | 950 | 5 | 4 | 60 | 0.23 | 61 |
| 22 | B | 1,000 | 950 | 5 | 16 | 6 | 0.24 | 63 |
| 23 | C | 1,000 | 950 | 5 | 10 | 25 | 0.38 | 70 |
| 24 | C | 1,000 | 1,050 | 5 | 10 | 26 | 0.39 | 72 |
| 25 | M | 950 | 950 | 5 | 10 | 28 | 0.21 | 66 |
| 26 | A1 | 1,000 | 950 | 3 | 10 | 24 | 0.12 | 52 |
| 27 | B1 | 1,000 | 950 | 5 | 8 | 30 | 0.43 | 61 |
| 28 | C1 | 1,000 | 950 | 5 | 10 | 33 | 0.29 | 67 |
| 29 | D1 | 1,000 | 950 | 8 | 10 | 31 | 0.34 | 83 |
| 30 | D1 | 1,000 | 950 | 4 | 10 | 31 | 0.09 | 22 |
| 31 | E1 | 1,000 | 950 | 6 | 13 | 24 | 0.38 | 79 |
| 32 | F1 | 1,000 | 950 | 6 | 13 | 22 | 0.23 | 70 |
| 33 | G1 | 1,000 | 950 | 5 | 13 | 15 | 0.21 | 55 |
| 34 | H1 | 1,000 | 950 | 5 | 10 | 35 | 0.31 | 57 |
| 35 | I1 | 1,000 | 950 | 6 | 10 | 30 | 0.39 | 76 |
| 36 | J1 | 1,000 | 950 | 6 | 10 | 33 | 0.31 | 70 |
| 37 | K1 | 1,000 | 950 | 6 | 10 | 31 | 0.33 | 67 |
| 38 | L1 | 1,000 | 950 | 6 | 10 | 34 | 0.31 | 82 |
| 39 | M1 | 1,000 | 950 | 6 | 10 | 30 | 0.26 | 65 |
| 40 | D | 1,000 | 950 | 1 | 1 | 63 | 0.03 | 9 |
| 41 | E | 1,100 | 1,000 | 8 | 10 | 27 | 0.35 | 70 |
| 42 | F | 1,100 | 1,000 | 8 | 10 | 34 | 0.30 | 75 |
| 43 | G | 1,000 | 950 | 8 | 12 | 23 | 0.30 | 91 |

TABLE 3

| | | | Heating | | (5) Austenite grain | | | |
|---|---|---|---|---|---|---|---|---|
| | (3) Acid | | temperature | Tempering | size number | | (6) Tensile | (7) Resistance |
| Sample | pickling | (4) Cold | before quenching | temperature | | (Outermost | strength | to delayed |
| No. | properties | forgeability | [° C.] | [° C.] | (Inside) | surface) | [MPa] | fracture |
| 1 | P | P | 880 | 400 | 8.5 | 9.0 | 1,799 | P |
| 2 | P | P | 880 | 425 | 9.0 | 8.5 | 1,675 | P |
| 3 | P | P | 880 | 450 | 8.5 | 9.0 | 1,549 | P |
| 4 | P | P | 880 | 400 | 8.0 | 9.0 | 1,670 | P |
| 5 | P | P | 880 | 450 | 9.0 | 9.5 | 1,425 | P |
| 6 | P | P | 880 | 425 | 8.5 | 8.0 | 1,803 | P |
| 7 | P | P | 880 | 450 | 9.5 | 9.0 | 1,655 | P |
| 8 | P | P | 880 | 400 | 9.0 | 8.5 | 1,727 | P |
| 9 | P | P | 880 | 400 | 8.5 | 8.5 | 1,727 | P |
| 10 | P | P | 880 | 400 | 10.0 | 10.5 | 1,848 | P |
| 11 | P | P | 920 | 400 | 11.0 | 10.8 | 1,867 | P |
| 12 | P | P | 920 | 400 | 10.5 | 10.0 | 1,854 | P |
| 13 | P | P | 880 | 400 | 8.5 | 8.5 | 1,828 | P |
| 14 | P | P | 920 | 400 | 10.0 | 10.3 | 1,872 | P |
| 15 | P | P | 880 | 400 | 10.5 | 10.3 | 1,531 | P |
| 16 | P | P | 880 | 425 | 10.3 | 10.3 | 1,866 | P |
| 17 | P | P | 920 | 425 | 10.5 | 10.3 | 1,779 | P |
| 18 | P | P | 880 | 425 | 11.0 | 11.0 | 1,620 | P |
| 19 | P | P | 880 | 400 | 9.0 | 6.5 | 1,785 | F |
| 20 | F | — | — | — | — | — | — | — |
| 21 | P | F | — | — | — | — | — | — |
| 22 | F | — | — | — | — | — | — | — |
| 23 | P | P | 880 | 425 | 7.5 | 7.5 | 1,791 | P |
| 24 | P | P | 880 | 425 | 7.5 | 7.5 | 1,789 | P |
| 25 | P | P | 880 | 425 | 7.0 | 7.0 | 1,614 | P |
| 26 | P | P | 880 | 425 | 8.5 | 9.0 | 1,373 | P |
| 27 | P | P | 880 | 425 | 9.0 | 8.5 | 2,127 | F |
| 28 | P | P | 880 | 425 | 8.0 | 9.0 | 1,585 | F |
| 29 | F | — | — | — | — | — | — | — |
| 30 | P | P | 880 | 450 | 8.5 | 6.0 | 1,787 | F |
| 31 | P | P | 880 | 425 | 8.5 | 9.0 | 1,633 | F |
| 32 | P | F | — | — | — | — | — | — |
| 33 | P | P | 880 | 425 | 11.0 | 10.5 | 1,623 | F |
| 34 | P | P | 880 | 450 | 10.5 | 11.0 | 1,760 | F |
| 35 | P | P | 920 | 400 | 11.0 | 11.0 | 1,858 | F |
| 36 | F | — | — | — | — | — | — | — |
| 37 | P | F | — | — | — | — | — | — |
| 38 | P | F | — | — | — | — | — | — |
| 39 | P | F | — | — | — | — | — | — |
| 40 | P | F | — | — | — | — | — | — |
| 41 | P | P | 900 | 400 | 10.0 | 10.5 | 1,851 | P |
| 42 | P | P | 900 | 400 | 11.0 | 10.8 | 1,871 | P |
| 43 | P | P | 900 | 400 | 10.5 | 10.0 | 1,564 | P |

From these results, the following consideration can be made. The samples Nos. 1 to 18, 23 to 25, and 41 to 43 are inventive examples satisfying the requirements specified by the present invention. All these examples had high strength and excellent acid pickling properties, cold forgeability, and resistance to delayed fracture.

The samples Nos. 19 to 22 and 26 to 40 are examples not satisfying any requirement specified by the present invention.

In the sample No. 19, the average cooling rate I was so low that the decarburization progressed. In this example, since the C content in the position at a depth of 0.1 mm from the surface layer was small, the austenite crystal grains were coarsened by the quenching and tempering process. Consequently, this example was inferior in the resistance to delayed fracture.

In the sample No. 20, since the average cooling rate I was high, the amounts of martensite formed at the surface layer and in the D/4 position were large. This example could not ensure the sufficient ferrite area ratio and thus was inferior in the acid pickling properties.

In the sample No. 21, since the average cooling rate II was low, the amount of formed ferrite was large. In this example, the ferrite area ratio was extremely high, and the dispersibility of carbides in the annealing became deteriorated, thus degrading the cold forgeability.

In the sample No. 22, since the average cooling rate II was high, the amount of formed ferrite decreased. This example could not ensure the sufficient ferrite area ratio and thus was inferior in the acid pickling properties.

The sample No. 26 was an example of using a steel type A1 in which the C content was below the lower limit of the present invention. This example could not ensure the tensile strength of 1,400 MPa or more.

The sample No. 27 was an example of using a steel type B1 in which the C content was above the upper limit of the present invention. This example was inferior in the resistance to delayed fracture because the toughness and ductility of the wire rod were degraded.

The sample No. 28 was an example of using a steel type C1 in which the Si content was below the lower limit of the present invention. This example was inferior in the resistance to delayed fracture because coarse grains of cementite were precipitated during the tempering process.

The sample No. 29 was an example of using a steel type D1 in which the Si content was above the upper limit of the present invention. In this example, an amorphous layer was formed on the surface layer of the wire rod, thereby deteriorating its acid pickling properties.

The sample No. 30 was an example of using a steel type D1 in which the Si content was above the upper limit of the present invention. In this example, the C content of the wire rod in the position at a depth of 0.1 mm from the surface layer was small, and the austenite crystal grains were coarsened by the quenching and tempering process. Consequently, this example was inferior in the resistance to delayed fracture.

The sample No. 31 was an example of using a steel type E1 in which the Mn content was below the lower limit of the present invention. This example was inferior in the resistance to delayed fracture because a large amount of FeS was formed.

The sample No. 32 was an example of using a steel type F1 in which the Mn content was above the upper limit of the present invention. This example was inferior in the cold forgeability because grains of MnS were coarsened.

The sample No. 33 was an example of using a steel type G1 in which the P content was above the upper limit of the present invention. This example was inferior in the resistance to delayed fracture because the toughness and ductility of the wire rod were degraded.

The sample No. 34 was an example of using a steel type H1 in which the S content was above the upper limit of the present invention. This example was inferior in the resistance to delayed fracture because the toughness and ductility of the wire rod were degraded.

The sample No. 35 was an example of using a steel type I1 in which the amount of added Cr was small. This example was inferior in the resistance to delayed fracture because the corrosion resistance of the wire rod was degraded.

The sample No. 36 was an example of using a steel type J1 in which the Cr content was above the upper limit of the present invention. Tn this example, a Cr enrichment layer was formed on the surface layer of the wire rod, thereby degrading its acid pickling properties.

The sample No. 37 was an example of using a steel type K1 in which the Al content was below the lower limit of the present invention. This example was inferior in the cold forgeability because ferrite crystal grains were coarsened.

The sample No. 38 was an example of using a steel type L1 in which the Al content was above the upper limit of the present invention. This example was inferior in the cold forgeability because coarse grains of AlN were formed.

The sample No. 39 was an example of using a steel type M1 in which the N content was above the upper limit of the present invention. This example was inferior in the cold forgeability because the amount of solid-solution N was increased.

In the sample No. 40, since both the cooling rates I and II were slow, the amount of formed ferrite was large, and further, the decarburization rate was high. In this example, the ferrite area ratio was extremely high, and the dispersibility of carbides in the annealing became deteriorated, thus degrading the cold forgeability.

1. A wire rod that has excellent acid pickling properties and resistance to delayed fracture after quenching and tempering, comprising, in percent by mass:
C: 0.3 to 0.6%;
Si: 1.0 to 3.0%;
Mn: 0.1 to 1.5%;
P: more than 0% and 0.020% or less;
S: more than 0% and 0.020% or less;
Cr: 0.3 to 1.5%;
Al: 0.02 to 0.10%;
N: 0.001 to 0.020%;
iron and inevitable impurities,
wherein
in a d×¼ position of the wire rod, where d is a diameter of the wire rod, a ferrite area ratio is in a range of 10 to 40%, with the remaining microstructure being bainite, pearlite and an inevitably formed microstructure, and
a C content in a position at a depth of 0.1 mm from a surface layer of the wire rod is in a range of 50 to 100% of a C content in a base material.

2. The wire rod according to claim 1, further comprising, in percent by mass, at least one selected from the group consisting of (a) to (e):
(a) at least one element selected from the group consisting of Cu: more than 0% and 0.5% or less, Ni: more than 0% and 1.0% or less, and Sn: more than 0% and 0.5% or less,
(b) at least one element selected from the group consisting of Ti: more than 0% and 0.1% or less, Nb: more than 0% and 0.1% or less, and Zr: more than 0% and 0.3% or less,
(c) at least one element selected from the group consisting of Mo: more than 0% and 3% or less and W: more than 0% and 0.5% or less,
(d) V: more than 0% and 0.5% or less, and
(e) at least one element selected from the group consisting of Mg: more than 0% and 0.01% or less and Ca: more than 0% and 0.01% or less.

3. A bolt that has excellent resistance to delayed fracture obtained from the wire rod according to claim 1, wherein a tensile strength of the bolt is 1,400 MPa or more, and each of austenite grain size numbers both at a surface layer of the bolt and in the d×¼ position of the bolt, where d is a diameter of a bolt shaft part, is No. 7.0 or more.

4. A bolt that has excellent resistance to delayed fracture obtained from the wire rod according to claim 2, wherein a tensile strength of the bolt is 1,400 MPa or more, and each of austenite grain size numbers both at a surface layer of the bolt and in the d×¼ position of the bolt, where d is a diameter of a bolt shaft part, is No. 7.0 or more.

5. The wire rod according to claim 2, comprising (a).

6. The wire rod according to claim 2, comprising (b).

7. The wire rod according to claim 2, comprising (c).

8. The wire rod according to claim 2, comprising (d).

9. The wire rod according to claim 2, comprising (e).
